(19) United States
(12) Patent Application Publication
(10) Pub. No.: US 2025/0227277 A1
(43) Pub. Date: Jul. 10, 2025

(54) SYSTEMS AND METHODS FOR ADAPTIVE DECODER SIDE PADDING IN VIDEO REGION PACKING

(71) Applicant: OP Solutions LLC, Amherst, MA (US)

(72) Inventors: Hari Kalva, Boca Raton, FL (US); Borivoje Furht, Boca Raton, FL (US); Velibor Adzic, Canton, GA (US); Alena Krause, Coconut Creek, FL (US)

(73) Assignee: OP Solutions LLC, Amherst, MA (US)

(21) Appl. No.: 19/089,130

(22) Filed: Mar. 25, 2025

Related U.S. Application Data
(63) Continuation of application No. PCT/US2023/033792, filed on Sep. 27, 2023.
(60) Provisional application No. 63/410,285, filed on Sep. 27, 2022.

(51) Int. Cl. H04N 19/44; H04N 19/169; H04N 19/60

(52) U.S. Cl. CPC H04N 19/44; H04N 19/188; H04N 19/60

(57) ABSTRACT

Systems and methods for video encoding and decoding for machines consumption are disclosed. A decoder is provided for a decoding a bitstream encoded with a packed frame having at least on region of interest defined therein and encoded region parameters associated therewith. The decoder includes a video decoder receiving the bitstream and extracting the packed frame and region parameters. A region unpacking module receives the packed frame and region parameters and reconstructs an unpacked frame with at least one region of interest. A region padding module is provided in the decoder and applies at least one padding parameter to at least one dimension of a region of interest in the unpacked frame. The region padding may be fixed or dynamic.

### CROSS REFERENCE TO RELATED APPLICATIONS

The present application is a continuation of international application PCT/US2023/33792 filed on Sep. 27, 2023, and entitled SYSTEM AND METHOD FOR ADAPTIVE DECODER SIDE PADDING IN VIDEO REGION PACKING, which claims the benefit of priority to U.S. Provisional Patent Application 63/410,285 filed on Sep. 27, 2022, and entitled “SYSTEM AND METHOD FOR ADAPTIVE DECODER SIDE PADDING IN VIDEO REGION PACKING,” which is hereby incorporated by reference in its entirety.

### FIELD OF THE DISCLOSURE

The present invention generally relates to the field of video encoding and decoding. In particular, the present invention is directed to video coding for machines (VCM) encoder, VCM decoder, and a VCM bitstream.

### BACKGROUND OF THE DISCLOSURE

Recent trends in robotics, surveillance, monitoring, Internet of Things, etc. introduced use cases in which a significant portion of all the images and videos that are recorded in the field are consumed by machines only, without ever reaching human eyes. Those machines process images and videos to complete tasks such as object detection, object tracking, segmentation, event detection, etc. Recognizing that this trend is prevalent and will only accelerate in the future, international standardization bodies established efforts to standardize image and video coding that is primarily optimized for machine consumption. For example, standards like JPEG AI and Video Coding for Machines are initiated in addition to already established standards such as Compact Descriptors for Visual Search, and Compact Descriptors for Video Analytics. Solutions that improve efficiency compared to the classical image and video coding techniques are needed. One such solution is presented here.

### SUMMARY OF THE DISCLOSURE

Various objects, features, aspects, and advantages of the inventive subject matter will become more apparent from the following detailed description of embodiments, along with the accompanying drawing figures in which like numerals represent like components.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

The present invention relates to a video encoding and decoding systems for machine-based consumption and methods for video encoding and decoding for the same.

According to an aspect of the invention, a video encoding system for machine-based consumption includes an encoder having an inference with region extractor adapted to receive a video input and generate a first encoded output, a region transformer and packer adapted to receive the first encoded output and generate a second encoded output with region packing, an adaptive video encoder adapted to receive the second encoded output and generate a compressed bitstream, wherein the compressed bitstream contains encoded packed regions along with parameters needed to reconstruct and reposition each region in a decoded frame and padding information.

According to another aspect of the invention, a video decoding system for machine-based consumption, comprises a decoder having an adaptive video decoder adapted to receive compressed bitstream containing encoded packed regions along with parameters needed to reconstruct and reposition each region in a decoded frame and provide a first decoded output, an unpacker and de-transformer adapted to receive the first decoded output and provide an output video with adaptive padding transformation in the region packing, wherein the unpacker and de-transformer receives unpacked reconstructed video and provides selectively padded regions for machine task evaluation.

In an embodiment, a decoder is provided for decoding a bitstream encoded with a packed frame having at least on region of interest defined therein and encoded region parameters associated therewith. The decoder includes a video decoder receiving the bitstream and extracting the packed frame and region parameters therefrom. A region unpacking module is provided which receives the packed frame and region parameters and reconstructs an unpacked frame with said at least one region of interest. The decoder further includes a region padding module receiving the unpacked frame and region parameters and applying at least one padding parameter to at least one dimension of a region of interest in the unpacked frame.

In certain embodiments the region padding module may receive adaptive padding parameters and the applied padding parameters are determined at least in part on said adaptive padding parameters.

In certain embodiments, the regions of interest are defined by rectangular bounding boxes and the applied padding parameters are pixels of a predetermined color added to at least one boundary of the region bounding box. Alternatively, the applied padding parameters can be pixels of an average color determined by the pixels within the region, the pixels being added to at least one boundary of the bounding box.

In some embodiments, the applied padding parameters are fixed number of pixels. Alternatively, the region padding module further receives adaptive padding parameters and the applied padding parameters can be a variable number of pixels determined at least in part by the adaptive padding parameters.

In some cases, the padding parameters may take the form of repeating pixels at the edge of a region of interest. Additionally or alternatively, a padding value can be signaled in the bitstream and the padding parameter is determined at least in part on the padding value.

In an embodiment, the packed object frames are sent to the adaptive video encoder that is adapted to receive and process the same to produce the compressed bitstream, wherein the adaptive video encoder is adapted to signal additional parameters for use in reconstruction processes at a decoder side including signaling which pixels should be used for decoder side padding.

In an embodiment, the adaptive video decoder receives the compressed bitstream and decodes the same to produce a packed region frame along with its signaled region information.

In an embodiment, the signaled region information includes parameters needed for reconstruction of the frame along with any additional parameters incorporated to perform padding transformations on the unpacked frames.

In an embodiment, the unpacker and de-transformer is adapted to process each of the unpacked frames based on region parameters and one or more adaptive parameters to extend region pixels to provide more context for endpoint machine task evaluation by a machine task system.

According to one more aspect of the present invention, a method of video encoding for machine-based consumption, comprises receiving, via an inference with region extractor, a video input and generating a first encoded output, receiving, via a region transformer and packer, the first encoded output and generating a second encoded output with region packing, receiving, via an adaptive video encoder, the second encoded output and generating a compressed bitstream, wherein the compressed bitstream contains encoded packed regions along with parameters needed to reconstruct and reposition each region in a decoded frame and padding information.

According to another aspect of the present invention, a method of video decoding for machine-based consumption, comprises receiving, by an adaptive video decoder, compressed bitstream containing encoded packed regions along with parameters needed to reconstruct and reposition each region in a decoded frame and provide a first decoded output, receiving, by an unpacker and de-transformer, the first decoded output and provide an output video with adaptive padding transformation in region packing, wherein the unpacker and de-transformer receives unpacked reconstructed video as part of the first decoded output and provides selectively padded regions in the output video for machine task evaluation.

According to an aspect of the present invention, a method for video compression in a machine-based video processing system, comprising the steps of identifying significant regions within a frame or image using an encoder side region detector module, extracting the identified significant image regions using an extraction module, tightly packing the significant image regions into a single frame using a region packing module, processing the packed regions through a video encoder to produce a compressed bitstream, wherein the compressed bitstream contains encoded packed regions along with parameters needed to reconstruct and reposition each region in a decoded frame and padding information.

According to an aspect of the present invention, a method for video decoding in a machine-based video processing system, comprising the steps of decoding a compressed bitstream using a video decoder to produce a packed region frame, unpacking the region frames and returning them to their original positions within the context of the original video frame using a region unpacking module, applying adaptive padding transformations to the unpacked frames, and providing additional context for machine task evaluation using a region padding module.

According to an aspect of the present invention, a method for padding in video compression, comprising the steps of including padding information in a compressed bitstream to be added at the decoder, determining the type of padding and padding size, wherein the padding size can vary on each side of rectangular regions, using different padding types, including repeating edge pixels, using the average color of pixels in the region, or including a padded pixel value in the bitstream, adaptively determining padding based on the characteristics of objects in a region.

According to an aspect of the present invention, a method of video encoding and decoding for machine-based consumption, comprising encoding a video input using an inference with region extractor to generate a first encoded output, further encoding the first encoded output using a region transformer and packer to generate a second encoded output with region packing, encoding the second encoded output using an adaptive video encoder to generate a compressed bitstream with padding information, decoding a compressed bitstream using an adaptive video decoder to provide a first decoded output, unpacking and de-transforming the first decoded output using an unpacker and de-transformer to provide an output video with adaptive padding transformation in the region packing, wherein the unpacker and de-transformer receives unpacked reconstructed video and provides selectively padded regions for machine task evaluation.

Further disclosed is a computer-readable medium having stored thereon instructions that, when executed by a processor, cause the processor to perform steps comprising encoding a video input using an inference with region extractor to generate a first encoded output, further encoding the first encoded output using a region transformer and packer to generate a second encoded output with region packing, encoding the second encoded output using an adaptive video encoder to generate a compressed bitstream, wherein the compressed bitstream contains encoded packed regions along with parameters needed to reconstruct and reposition each region in a decoded frame and padding information.

In another aspect, a computer-readable medium having stored thereon instructions that, when executed by a processor, cause the processor to perform steps comprising decoding a compressed bitstream using an adaptive video decoder to provide a first decoded output, unpacking and de-transforming the first decoded output using an unpacker and de-transformer to provide an output video with adaptive padding transformation in the region packing, wherein the unpacker and de-transformer receives unpacked reconstructed video and provides selectively padded regions for machine task evaluation.

### BRIEF DESCRIPTION OF THE DRAWINGS

FIG. 1 is a block diagram of a system for encoding and decoding video for machines, such as in a system for Video Coding for Machines (VCM), with region packing, in accordance with an embodiment of the present disclosure.

FIG. 2 is a detailed block diagram of a system of FIG. 1 for encoding and decoding video for machines, in accordance with an embodiment of the present disclosure.

FIG. 3 is a pictorial representation that illustrates the adaptive region padding in accordance with the present disclosure.

### DETAILED DESCRIPTION OF EMBODIMENTS

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

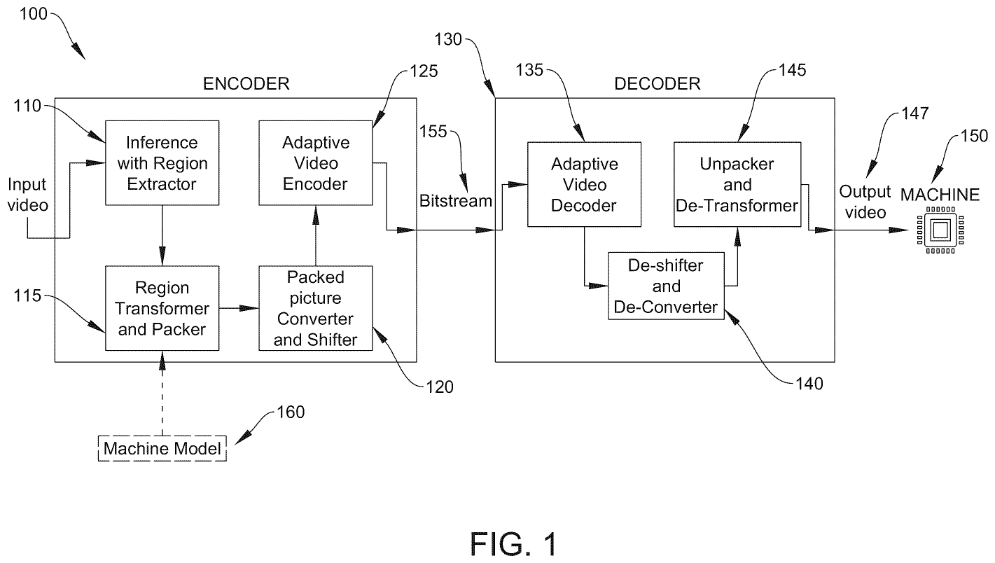

FIG. 1 is a block diagram illustrating an exemplary embodiment of a VCM coding system comprising an encoder, a decoder, and a bitstream well suited for machine-based consumption of video, such as contemplated in applications for Video Coding for Machines (“VCM”). As used herein, the term VCM is not limited to a specific proposed protocol but more generally includes all systems for coding and decoding video for machine consumption. While FIG. 1 has been simplified to depict the components used in coding for machine consumption, it will be appreciated that the present systems and methods are applicable to hybrid systems which also encode, transmit, and decode video for human consumption as well. Such systems for encoding/decoding video using various protocols, such as HEVC, VVC, AV1, and the like, are generally known in the art.

Referring to FIG. 1, an exemplary embodiment of a VCM coding system 100 comprising of a VCM encoder 105, a VCM bitstream 155, and a VCM decoder 130 is illustrated.

Further referring to FIG. 1, an exemplary embodiment of an encoder for video coding for machines (VCM) is illustrated. VCM encoder 105 may be implemented using any circuitry including without limitation digital and/or analog circuitry; VCM encoder 105 may be configured using hardware configuration, software configuration, firmware configuration, and/or any combination thereof. VCM encoder 105 may be implemented as a computing device and/or as a component of a computing device, which may include without limitation any computing device as described below. In an embodiment, VCM encoder 105 may be configured to receive an input video 102 and generate an output bitstream 155. Reception of an input video 102 may be accomplished in any manner described below. A bitstream may include, without limitation, any bitstream known in the art for advanced CODECS such as HEVC, AV1 or VVC or as described below. VCM encoder 105 may include, without limitation, an inference with region extractor 110, a region transformer and packer 115, a packed picture converter and shifter 120, and/or an adaptive video encoder 125.

The Packed Picture Converter and Shifter 120 process the packed image so that further redundant information is removed before encoding. Examples of conversion are conversions of color space, (e.g. converting from the RGB to grayscale), quantization of the pixel values (e.g. reducing the range of represented pixel values, and thus reducing the contrast), and other conversions that remove redundancy in the sense of machine model. Shifting entails the reduction of the range of represented pixel values by direct right-shift operation (e.g. right-shifting the pixel values by 1 is equivalent to dividing all values by 2). Both conversions and shifting are reversed on the decoder side by block 140, using the inverse mathematical operations to the ones used in 120.

Further referring to FIG. 1, the adaptive video encoder 125 may include without limitation any video encoder known in the art for advanced CODEC standards, such as HEVC, AV1, VVC and the like, or as described in further detail below.

Still referring to FIG. 1, which illustrates an exemplary embodiment of a decoder for VCM. VCM decoder 130 may be implemented using any circuitry including without limitation digital and/or analog circuitry; VCM decoder 130 may be configured using hardware configuration, software configuration, firmware configuration, and/or any combination thereof. VCM decoder 130 may be implemented as a computing device and/or as a component of a computing device, which may include without limitation any computing device as described below. In an embodiment, VCM decoder 130 may be configured to receive an input bitstream 155 and generate an output video 147. Reception of a bitstream 155 may be accomplished in any manner described below. A bitstream may include, without limitation, any bitstream as described below.

With continued reference to FIG. 1, a machine model 160 may be present in the VCM encoder 105, or otherwise sent to it in an online or offline mode using an available communication channel. Machine model 160 contains information that completely describes machine 150 requirements for task completion. This information can be used by the VCM encoder 105, and in some embodiments specifically by the region transformer and packer 115.

Given a frame of a video or an image, effective compression of such media can be achieved by detecting and extracting its important regions and packing them into a single frame. Simultaneously, the system discards any detected regions that are not of interest. These packed frames serve as input to an encoder to produce a compressed bitstream. The produced bitstream contains the encoded packed regions along with parameters needed to reconstruct and reposition each region in the decoded frame. A machine task system 150 can perform designated machine tasks, such as computer vision-related functions, on the reconstructed video frames.

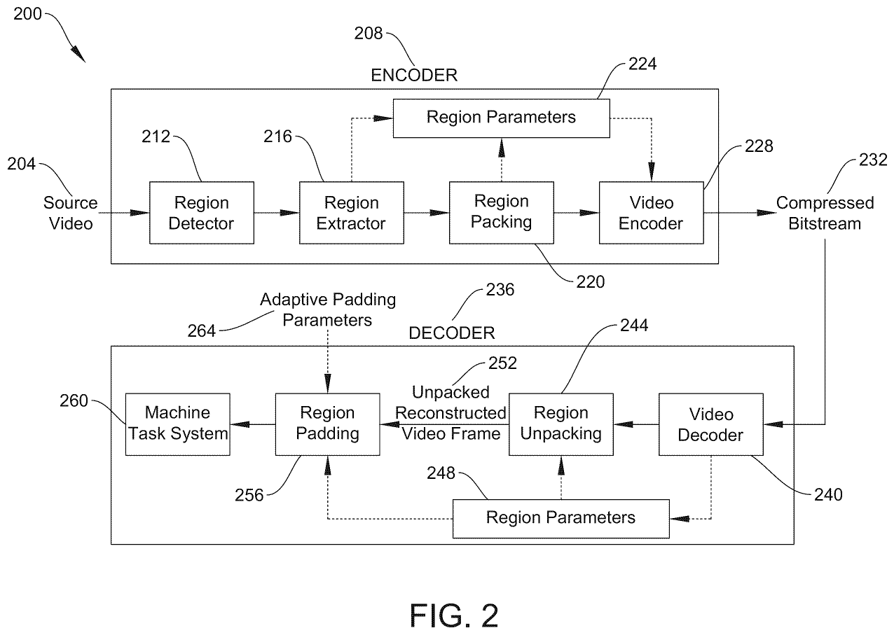

Such a video compression system may be improved through additional processing performed on the unpacked frame. The improved system provides a decoder-side region padding method to provide better context for endpoint machine task evaluation. FIG. 2 shows the proposed video compression system 100 which comprises encoder side modules and decoder side modules, including decoder side region padding.

FIG. 2 is a detailed block diagram showing sub-components of the VCM coding system of FIG. 1, in accordance with an embodiment of the present disclosure. The system, referred to by reference numeral 200 herein onwards, shows an encoder 208 and a decoder 236. The encoder 208 includes a region detection block 212, a region extractor block 216, a region packing block 220, region parameters block 224, and a video encoder block 228 which cooperate to generate a compressed bitstream 232.

The decoder 236 includes a video decoder 240 that receives the compressed bitstream 232, a region unpacking module 244 coupled to region parameters module 248, which generates unpacked reconstructed video frames 252. A region padding module 256 coupled to adaptive padding parameters 264 receives the unpacked reconstructed video from region unpacking module 244 and provides the selectively padded regions for the machine task system 260.

### Region Detection and Extraction

Significant frame or image regions are identified using the encoder side region detector module 212, which produces coordinates of discovered objects. Saliency-based detection methods using video motion may also be employed to identify important regions. Resulting coordinates are used to determine regions for packing and enable the identification of pixels deemed as unimportant to the detection module. Such unimportant regions may be discarded and are not used in packing. The region extraction module 216 extracts pixels for the image regions identified by 212 and prepares the coordinates to be used through the rest of the pipeline. The extraction module may output additional parameters to be encoded in 228. This may include information about which of the packed regions should receive decoder side padding and by what amount.

### Region Packing

The extracted region box coordinates, returned from the extraction module 216, serve as input to the region packing system 220. The region packing module extracts the significant image regions and packs them tightly into a single frame. The region packing module 220 produces packing parameters that will be signaled in the bitstream 232, such as in header information or supplemental information signaled in the bitstream.

### Video Encoding

Packed object frames are processed through video encoder 228 to produce the compressed bitstream 232. The compressed bitstream includes the encoded packed regions along with the parameters 224 needed to reconstruct and reposition each region in the decoded frame. Additional parameters may be signaled for use in the decoder side 236 reconstruction processes such as signaling which pixels should be used for decoder side padding. Encoding is not limited to any particular standard and can substantially conform to known CODEC protocols, such as HEVC, AV1, VVC and the like or variants thereof.

### Video Decoding

The compressed bitstream 232 is decoded by the video decoder 240 to produce a packed region frame along with its signaled region parameter information from region parameter module 248. This region information generally includes parameters needed for the reconstruction of the frame such as region coordinates, object type, and the like, along with any additional parameters incorporated to perform padding transformations on the unpacked frames.

### Region Unpacking

The decoded parameters are used to unpack the region frames via region unpacking module 244. Each region of interest identified at the encoder 208 is returned to its position within the context of the original video frame. The resulting unpacked frame only includes the pixels for regions of interest determined by the region detection system 212 and does not include the discarded pixels.

The proposed padding module 256 considers region parameters 248 along with any adaptive parameters in 264 to apply further processing to the unpacked frame. Such further processing focuses on extending region pixels to provide more context for endpoint machine task evaluation performed by module 260.

Padding methods may use a variety of techniques for extending region boundaries. This includes direct extension of edge pixels or filling edge pixels with a specified color. Such a specified color may be signaled from decoded parameters 248 or can simply be applied using an average of pixel colors found in the region boxes. Additionally, prediction techniques may also be applied such as inpainting to reconstruct edge pixels around regions. Similarly, a specified patch of pixels may be signaled in the bitstream and tiled across the region edges to create new textures around the regions. Such transformations, applied to the unpacked frame, serve to provide additional context for machine-related tasks performed by machine task system 260. Applying padding to the reconstructed frames may avoid any need for encoder-side region padding to be performed, ultimately reducing the number of bits transmitted.

The compressed bitstream can include padding information to be added to the decoder. Such padding description may be included in the region description information. The padding information preferably contains information that includes the type of padding and padding size. Padding size can vary on each side of rectangular regions. Type of padding signals to the decoder how to obtain pixels used for padding. In one signaled padding type, the edge pixels of the region are repeated up to the padding size. In another signaled padding type, the average color of pixels in the region are used for padding. In yet another signaled padding type, padded pixel value is included in the bitstream. Padding can also be adaptively determined based on the characteristics of objects in a region.

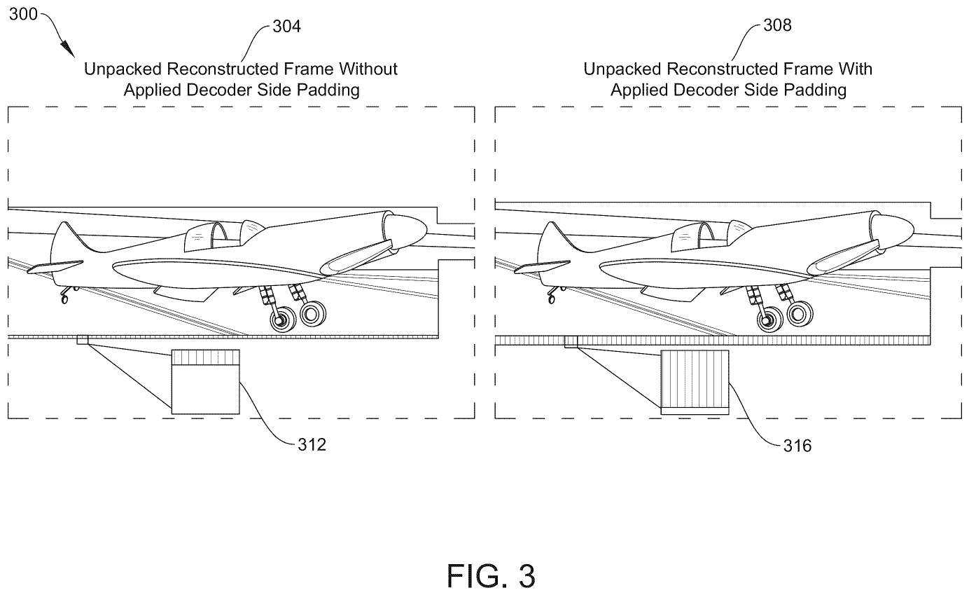

FIG. 3 shows an example 300 of extended region boundaries performed by padding module 256. In this diagram, image 308 is the decoder-side padded version of the image in 304. A small patch of the extended region pixels is shown by numeral 316. Numeral 312 shows the same patch of pixels taken from the corresponding region in the image without applied padding. Extension of edge pixels in the former case works well to reconstruct region boundaries without introducing any new artifacts or textures that could negatively impact machine analysis.

### Machine Task

The reconstructed, unpacked, and padded video frame 252 is used as input to machine task system 260 which may perform computer vision-related functions. Machine task performance on the unpacked and padded frames may be analyzed and used to determine techniques for applied padding techniques on a per-frame basis. Optimized parameters 264 may be updated and signaled to the decoder side pipeline to effectively pad regions in unpacked frames.

Some embodiments may include non-transitory computer program products (i.e., physically embodied computer program products) that store instructions, which when executed by one or more data processors of one or more computing systems, cause at least one data processor to perform operations herein.

Embodiments may include circuitry configured to implement any operations as described above in any embodiment, in any order, and with any degree of repetition. For instance, modules, such as encoder or decoder, may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Encoder or decoder may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Non-transitory computer program products (i.e., physically embodied computer program products) may store instructions, which when executed by one or more data processors of one or more computing systems, cause at least one data processor to perform operations, and/or steps thereof described in this disclosure, including without limitation any operations described above and/or any operations decoder and/or encoder may be configured to perform. Similarly, computer systems are also described that may include one or more data processors and memory coupled to one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in software art. Aspects and implementations discussed above employing software and/or software modules may also include appropriate hardware for assisting in the implementation of the machine-executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present invention, the preferred, systems and methods are now described.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and the illustrative examples shown and described. Thus, this application is intended to embrace alterations, modifications, and variations that fall within the scope of the appended claims.

Moreover, although the present invention and its advantages have been described in detail, it should be understood that various changes, substitutions, and alterations can be made herein without departing from the invention as defined by the appended claims. Moreover, the scope of the present application is not intended to be limited to the particular embodiments of the process, machine, manufacture, and composition of matter, means, methods, and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

The preceding description has been presented with reference to various embodiments. Persons skilled in the art and technology to which this application pertains will appreciate that alterations and changes in the described structures and methods of operation can be practiced without meaningfully departing from the principle, and scope.

What is claimed:

1. A decoder for a decoding a bitstream encoded with a packed frame having at least on region of interest defined therein and encoded region parameters associated therewith, the decoder comprising:
a video decoder receiving the bitstream and extracting the packed frame and region parameters therefrom;
a region unpacking module, the region unpacking module receiving the packed frame and region parameters and reconstructing an unpacked frame with said at least one region of interest; and
a region padding module, the region padding module receiving the unpacked frame and region parameters and applying at least one padding parameter to at least one dimension of a region of interest in the unpacked frame.

2. The decoder of claim 1, wherein the region padding module further receives adaptive padding parameters and wherein said applied padding parameters are determined at least in part on said adaptive padding parameters.

3. The decoder of claim 1, wherein the regions of interest are defined by rectangular bounding boxes and wherein the applied padding parameters are pixels of a predetermined color added to at least one boundary of the region bounding box.

4. The decoder of claim 1, wherein the regions of interest are defined by rectangular bounding boxes and wherein the applied padding parameters are pixels of an average color determined by the pixels within the region, the pixels being added to at least one boundary of the bounding box.

5. The decoder of claim 3 or 4, wherein the applied padding parameters are a fixed number of pixels.

6. The decoder of claim 3 or 4, wherein the region padding module further receives adaptive padding parameters and wherein said applied padding parameters comprise a variable number of pixels determined at least in part by the adaptive padding parameters.

7. The decoder of claim 3 or 4, wherein the padding parameters comprise repeating pixels at the edge of a region of interest.

8. The decoder of claim 3 or 4, wherein a padding value is signaled in the bitstream and the padding parameter is determined at least in part on the padding value.

9. A method of decoding a bitstream having a packed frame with at least one region of interest defined therein and encoded region parameters associated therewith, the decoder comprising:
receiving the bitstream;
extracting the packed frame and region parameters from the bitstream;
and reconstructing an unpacked frame with said at least one region of interest from the packed frame and region parameters; and
applying at least one padding parameter to at least one dimension of a region of interest in the unpacked frame.

10. The method of claim 9 further comprising receiving adaptive padding parameters and wherein said applied padding parameters are determined at least in part from said adaptive padding parameters.

11. The method of claim 9, wherein the regions of interest are defined by rectangular bounding boxes and wherein the applied padding parameters are pixels of a predetermined color added to at least one boundary of the region bounding box.

12. The method of claim 9, wherein the regions of interest are defined by rectangular bounding boxes and wherein the applied padding parameters are pixels of an average color determined by the pixels within the region, the pixels being added to at least one boundary of the bounding box.

13. The method of claim 9, wherein the applied padding parameters are a fixed number of pixels.

14. The method of claim 9, further comprising receiving adaptive padding parameters and wherein said applied padding parameters comprise a variable number of pixels determined at least in part by the adaptive padding parameters.

15. The method of claim 9, wherein the padding parameters comprise repeating pixels at the edge of a region of interest.

16. The method of claim 9, wherein a padding value is signaled in the bitstream and the padding parameter is determined at least in part on the padding value.

17. A computer-readable medium having stored thereon instructions that, when executed by a processor, cause the processor to perform steps comprising:
decoding a compressed bitstream using an adaptive video decoder to provide a first decoded output;
unpacking and de-transforming the first decoded output using an unpacker and de-transformer to provide an output video with adaptive padding transformation in the region packing, wherein the unpacker and de-transformer receives unpacked reconstructed video and provides selectively padded regions for machine task evaluation.
